(19) United States
(12) Patent Application Publication
(10) Pub. No.: US 2005/0034067 A1
(43) Pub. Date: Feb. 10, 2005

(54) Document processor, printing system, method of adding object to document and program

(75) Inventor: Kazuhiro Inoue, Kyoto (JP)

Correspondence Address: MCDERMOTT, WILL & EMERY, 600 13th Street, N.W., WASHINGTON, DC, 20005-3096, US

(73) Assignee: DAINIPPON SCREEN MFG. CO., LTD.

(21) Appl. No.: 10/893,966

(22) Filed: Jul. 20, 2004

(30) Foreign Application Priority Data
Aug. 7, 2003 (JP) JP 2003-289043

(51) Int. Cl. G06F 17/00

(52) U.S. Cl. 715/517

(57) ABSTRACT

A method of processing for use when an overlap occurs between an object to be added and an object existing in a document is previously selected among a placement position correction process, an additional object transparentizing process, an existing object transparentizing process, an overwriting process, an existing object deletion process and the like. On predetermined determination conditions, a determination is made sequentially for each page as to whether or not an overlap occurs between these objects. If the overlap occurs in a large number of pages, the planned placement position of the additional object can be set again. An object addition process is automatically performed sequentially on each page, based on obtained determination result data and the determined overlap-image correction process method.

### BACKGROUND OF THE INVENTION

1. Field of the Invention

The present invention relates to an image processing technique for print data and, more particularly, to a technique for editing and correcting processes suitable for layout data about a document with a plurality of pages.

2. Description of the Background Art

In the process of creating a document with a plurality of pages and containing text and images, it is often desired to add layout elements (or objects) such as logos, banners and page numbers to all pages by one operation after the layout of all pages is done. In this process, an object sometimes exists in an area in which another object to be added is desired to be placed on some of the pages. If the object to be added is placed in the area without any processing in such a case, an overlap occurs between the added object and the previously placed object to impair what the respective objects are originally intended to express (or expressiveness). To avoid this, it is necessary to search for objects which will overlap other objects one by one to perform an adjustment process including correcting or changing the position of the objects to be placed so as to prevent the overlap.

Among such processes relating to the addition of objects, the process of adding page numbers has been disclosed in, for example, Japanese Patent No. 3394304 which shows a technique for automating such an adjustment process.

For addition of a small-sized object with a blank background such as a page number, it is effective to use the technique of turning black parts white and vice versa and correcting the position of the object to be added if an overlap occurs, as disclosed in Japanese Patent No. 3394304. However, the use of only the conventional manual operation and the method disclosed in Japanese Patent No. 3394304 creates a high likelihood that the expressiveness of the object to be added is impaired if the object to be added is an object which is previously created by precise color designation and which is not meaningful unless it is expressed as it is, for example if the object to be added is a corporate logo, banner, or the like, or if the object to be added has a complicated image pattern. Further, a large-sized object to be added might extend off a medium depending on the position of the object to be placed.

The manual correction, on the other hand, is extremely inefficient because it involves individual page-by-page operations in many cases, and requires more labor with more pages. Moreover, a visual check or manual check for the overlap between objects increases the likelihood of check error to become a factor responsible for degradation of the reliability of finished printed matter.

### SUMMARY OF THE INVENTION

The present invention is intended for an image processing technique for print data and, more particularly, to a technique for editing and correcting processes suitable for layout data about a document with a plurality of pages.

According to the present invention, a document processor for additionally placing a predetermined object onto at least one page of a document to be printed comprises: a) a placement plan information generation element for generating placement plan information, the placement plan information including a layout size of a first object to be additionally placed in the document, and a planned placement position of the first object in the document; b) an overlap determination element for performing an overlap determination process, the overlap determination process being the process of making a determination for each page as to whether or not an overlap occurs between the first object and a second object when the first object is additionally placed in the planned placement position, the second object being an object already existing in the document; c) at least one overlap-image correction processing element for performing a predetermined overlap-image correction process, in accordance with process selection information, on a page where it is determined that an overlap occurs by the overlap determination element, the overlap-image correction process being image processing for reducing invisibility resulting from the overlap between the first and second objects, the overlap-image correction process being performed on at least one of the first object and the second object; d) an overlap-image correction process selection element capable of selection of the overlap-image correction process among a plurality of types of overlap-image correction process candidates to generate the process selection information in the form of information containing a result of the selection; e) a page process determination element for performing a page determination process, the page determination process being the process of determining a method of addition of the first object for each page by reference to the placement plan information and the process selection information; and f) an appending processing element for appending data descriptions about the first object to layout data about the document in accordance with the method determined by the page process determination element, to create new layout data about the document.

When the first object is intended to be additionally placed in the document, the document processor according to the present invention efficiently accomplishes the determination as to whether or not an overlap occurs between the first object and the second object already existing on each page of the document, and the setting of the method of addition in accordance with a result of the determination, thereby shortening operating time.

Preferably, the at least one overlap-image correction processing element is at least one selected from the group consisting of: c-1) a placement correction processing element for performing a placement correction process, the placement correction process being the process of changing the placement position of the first object to a position different from the planned placement position; c-2) a first transparentizing processing element for performing a first object transparentizing process, the first object transparentizing process being the process of transparentizing the first object in accordance with a predetermined transparency; c-3) a second transparentizing processing element for performing a second object transparentizing process, the second object transparentizing process being the process of transparentizing the second object in accordance with a predetermined transparency; and c-4) a deletion processing element for performing a deletion process on the second object, the deletion process being the process of deleting the second object.

This efficiently accomplishes the selection of the overlap-image correction process more suitable to what the document or the objects express while impairing the expressiveness of the original document and the expressiveness of the first object to be added as little as possible.

It is therefore an object of the present invention to provide a document processor capable of adding an object to a document, if so desired, without impairing what the object is intended to express.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the construction of a printing system according to a first preferred embodiment of the present invention;

FIG. 2 is a diagram for illustrating the construction of a client computer;

FIG. 3 is a diagram for illustrating functions implemented in a control section of the client computer;

FIG. 4 illustrates an example of an overlap determination process;

FIG. 5 shows a process selection window by way of illustration;

FIGS. 6A and 6B show an example of an additional object transparentizing process;

FIGS. 7A and 7B show an example of an existing object transparentizing process;

FIG. 8 is a process flow diagram for overlap determination and overlap-image correction process selection;

FIG. 9 is a process flow diagram for an object addition process; and

FIG. 10 is a process flow diagram according to a second preferred embodiment of the present invention.

### DESCRIPTION OF THE PREFERRED EMBODIMENTS

### First Preferred Embodiment

<System Construction>

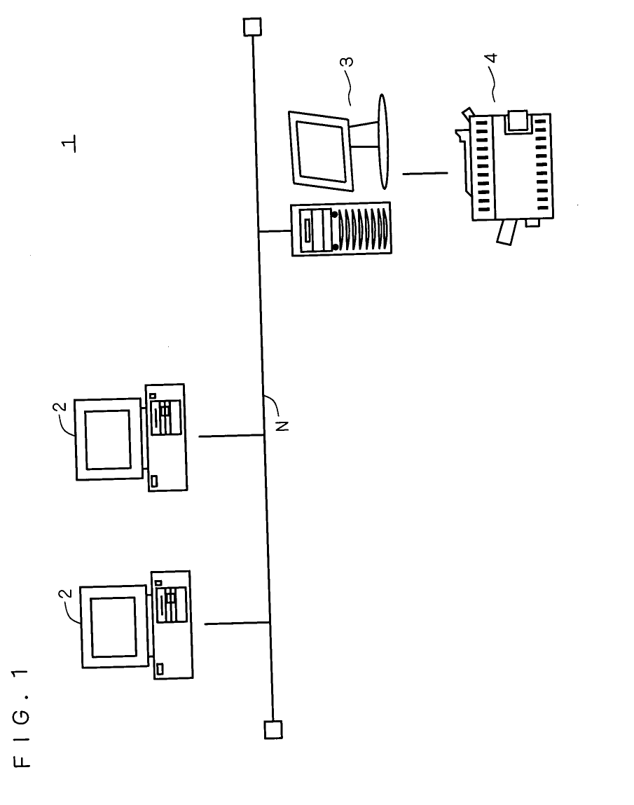

FIG. 1 schematically shows the construction of a printing system 1 according to a first preferred embodiment of the present invention. The printing system 1 is a client/server computer system principally comprising client computers 2, a printing machine controller 3 serving as a server connected through a network N to the client computers 2, and a printing machine 4 controlled by the printing machine controller 3. Although the two client computers 2 are shown in FIG. 1 by way of illustration, the printing system 1 may comprise one client computer 2 or three or more client computers 2.

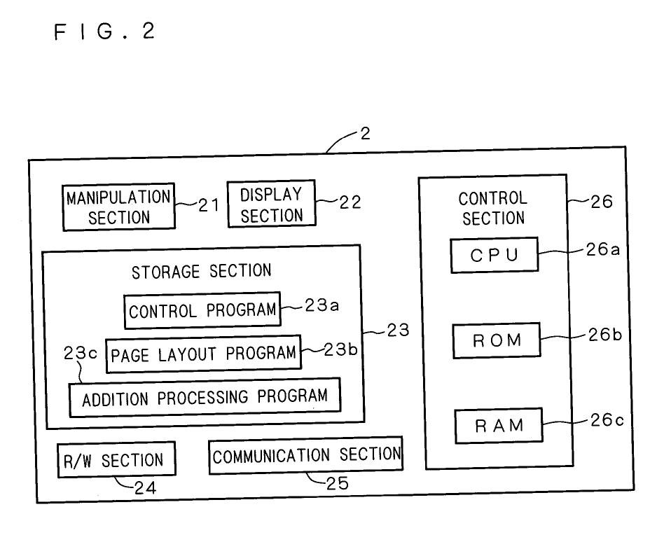

FIG. 2 is a diagram for illustrating the construction of the client computer 2. The client computer 2 functions as a document processor according to the present invention, and is, for example, a general-purpose personal computer (PC). The client computer 2 principally comprises: a manipulation section 21 including a mouse and a keyboard for an operator to enter various commands; a display section 22 such as a display device; a storage section 23 including a hard disk and the like for storing various programs and data therein; an R/W section 24 for reading and writing data from and to various portable recording media; a communication section 25 serving as an interface for transfer of data to and from the printing machine controller 3 through the network N; and a control section 26 including a CPU 26a, a ROM 26b and a RAM 26c for implementing functions to be described later.

In the client computer 2, a so-called GUI (Graphical User Interface) capable of processing while displaying the details of manipulation through the manipulation section 21 and the current status of various processes on the display section 22 is implemented by the functions of the control section 26, the manipulation section 21 and the display section 22. Processes in respective components to be described later which are implemented in the control section 26 are also carried out using the GUI.

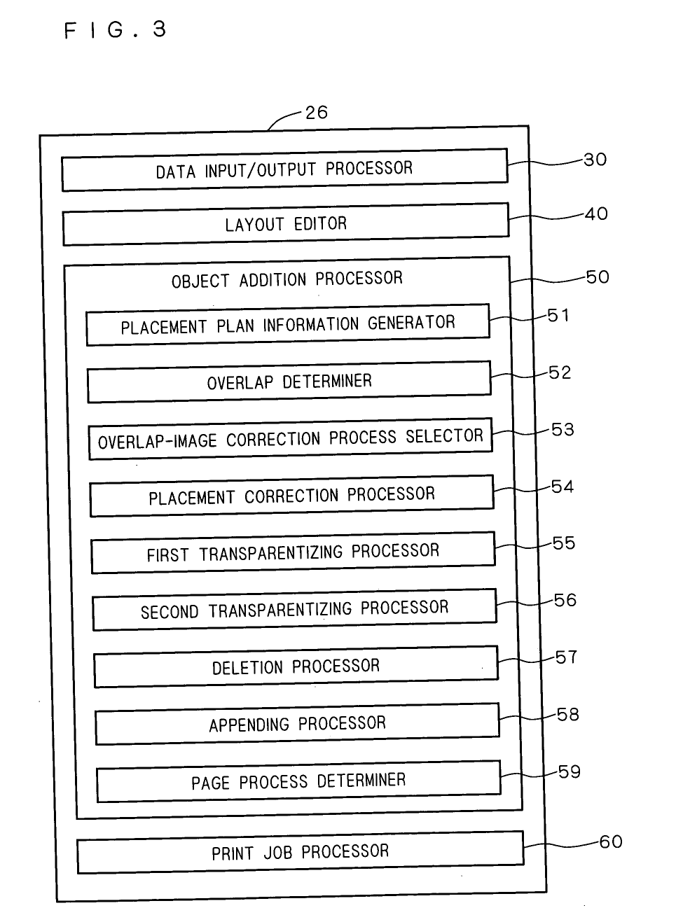

FIG. 3 is a diagram for illustrating the functions implemented in the control section 26 of the client computer 2. In the control section 26, a data input/output processor 30, a layout editor 40, an object addition processor 50 and a print job processor 60 are principally implemented by the execution of predetermined programs stored in the storage section 23 under the action of the CPU 26a, the ROM 26b and the RAM 26c. The predetermined programs specifically include a control program 23a for causing the personal computer to function as the client computer 2, a page layout program 23b responsible for a page layout process of a print (or printed matter), an addition processing program 23c responsible for an object addition process to be described later, and the like.

The data input/output processor 30 is responsible for reading and storing layout data and additional object data. Such reading and storage may be executed directly from the storage section 23, executed between a predetermined recording medium and the data input/output processor 30 through the R/W section 24, or executed between another client computer 2 and the data input/output processor 30 through the network N.

The layout editor 40 allows layout edition by means of the GUI. The layout editor 40 is a function principally implemented by the page layout program 23b, and is responsible for the process of creating the layout data about a print. Preferably, the page layout program 23b is a program suitable for creating a document with a plurality of pages. By the execution of the page layout program 23b, the layout editor 40 creates the layout data in which the details of the layout of a print are described on a page-by-page basis. The layout data is preferably written in a page description language (PDL). A program known in the art may be used as the page layout program 23b.

The object addition processor 50 is a function principally implemented by the addition processing program 23c, and is responsible for the process of adding some object, e.g. a logo and pagination, to the created layout data about a print with a plurality of pages, this process being performed on all of the pages by one operation. The object addition processor 50 principally includes the following components implemented therein: a placement plan information generator 51, an overlap determiner 52, an overlap-image correction process selector 53, a placement correction processor 54, a first transparentizing processor 55, a second transparentizing processor 56, a deletion processor 57, an appending processor 58, and a page process determiner 59.

The placement plan information generator 51 is responsible for the process of generating placement plan information about an object for a document to which an operator desires to add the object. The placement plan information is data containing a layout size (the vertical and horizontal dimensions in the document) of an object desired to be added (or an additional object), and a planned placement position of the additional object on the document. As an example, after a document of interest is previously read and any desired page of the document is displayed on the screen of the display section 22, data (image data, text data or the like) about the additional object is read, and the operator sets the planned placement position while appropriately moving the additional object on a layout screen for the document. When the planned placement position is set on the screen, the same position is set as the planned placement position of the additional object on all of the pages of the document including other pages not displayed. The planned placement position need not always be set while moving the additional object itself after the additional object is read, but may be set while moving on the screen a frame to be described later which is determined from the layout size (the vertical and horizontal dimensions in the document) of the additional object, in which case loads on data processing are reduced. The placement plan information established by setting the planned placement position is used for the next overlap determination process.

The overlap determiner 52 is responsible for the process (overlap determination process) of making a determination for all pages as to whether or not another object has been placed in the planned placement position of the additional object in the document. In other words, the overlap determiner 52 is responsible for the process of making a determination for all pages as to whether or not the placement of the additional object in the set planned placement position without any processing causes an overlap between the existing object and the additional object. When the layout data about the document is written, for example, in a PDL, placement position information (including a placement position, a layout size and the like) about objects placed on each page is described on a page-by-page basis. The overlap determiner 52 sequentially makes page-by-page determinations as to whether or not the placement of the additional object in the planned placement position causes an overlap between the existing object and the additional object, based on the descriptions of the placement position information and the placement plan information about the additional object. The results (determination result data) are displayed on the display section 22 either one by one or after the completion of the determinations for all pages. In the former case, if it is determined that the overlap occurs on many pages before the completion of the determinations for all pages, there is a high likelihood that the planned placement position is improper, and the operator can reconsider the planned placement position without the need to make the determinations for all pages. In the latter case, the results may be displayed in list form according to elements such as the degree and frequency of the overlap, and the operator can more unerringly determine the appropriateness of the planned placement position of the additional object.

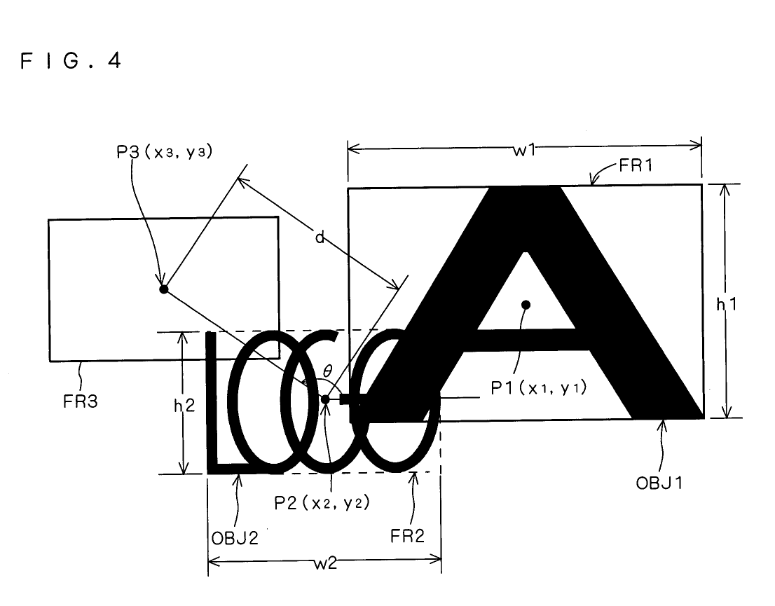

An example of the overlap determination process is shown with reference to FIG. 4. FIG. 4 shows a situation in which an additional object OBJ2 is intended to be placed in a position where an existing object OBJ1 has been placed on a certain page of a document. For ease of the determination process in this preferred embodiment, a rectangular frame is assumed whose vertical and horizontal dimensions (height and width) are the maximum vertical and horizontal dimensions (height and width), respectively, of each of the objects, and whether or not the objects overlap each other is determined from the positional relationship between the frames. Specifically, the central position P1(x1,y1), vertical dimension h1 and horizontal dimension w1 of a frame FR1 corresponding to the existing object OBJ1 are obtained from the placement position information about the existing object OBJ1 described in the layout data about the document. Similarly, the central position P2(x2,y2), vertical dimension h2 and horizontal dimension w2 of a frame FR2 corresponding to the additional object OBJ2 are obtained from the placement plan information about the additional object OBJ2. In this case, for example, the planned placement position of the additional object OBJ2 may be previously represented by the central position of the frame FR2. After the obtainment of the above-mentioned values, it is determined that the placement of the additional object without any processing causes an overlap between the objects when either Inequality (1) or Inequality (2) is satisfied.
|x2−x1≦(w1+w2)/2 (1)
|y2−y1≦(h1+h2)/2 (2)

This determination method is illustrative only, and other determination methods may be used.

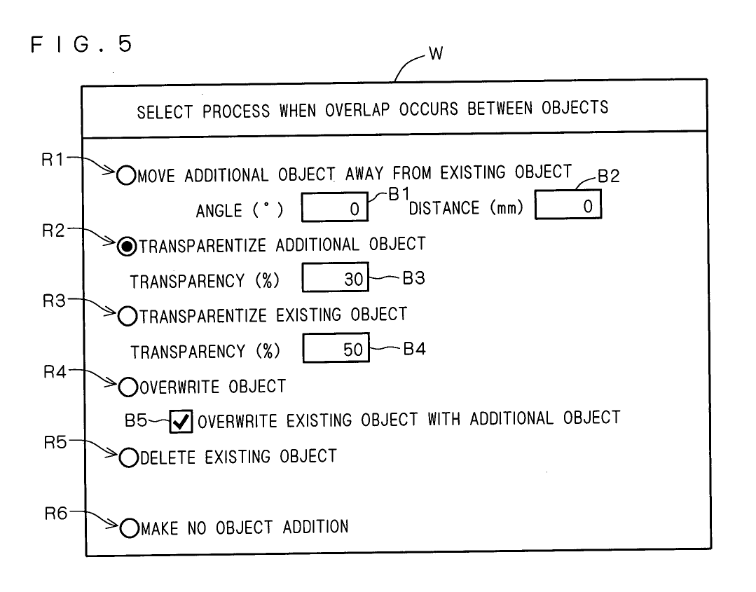

In response to operator's manual input through the manipulation section 21, the overlap-image correction process selector 53 is responsible for the process of selecting an overlap-image correction process to be actually used among a variety of processes (or a plurality of overlap-image correction process candidates) implementable in components to be described later if an overlap occurs between the objects as a result of the determination in the overlap determiner 52. FIG. 5 shows a process selection window W on the display section 22 implementable by the function of the overlap-image correction process selector 53 by way of illustration. When the operator selects any one item in a displayed process selection menu by using radio buttons R1 to R6 and does manual input such as the input of a predetermined parameter as required, the overlap-image correction process selector 53 obtains these as process selection information. The process selection information contains, for example, a process selection flag determined depending on the details of the selected process, and a parameter given depending on the selection, and is data provided for the processes in the respective components corresponding to the selection. If no overlap occurs, the process selection information so indicating shall be generated.

The placement correction processor 54 is responsible for the process (placement correction process) of correcting the placement position of the additional object if it is determined that an overlap occurs between the objects. In other words, the placement correction process corresponds to the process of moving the additional object from the initial placement position (planned placement position) in which the overlap occurs to a placement position in which no overlap occurs (or is considered to occur). For setting so as to perform the placement correction process if an overlap occurs between the existing object OBJ1 and the additional object OBJ2 as shown in FIG. 4, an angle θ and a distance d, for example, are previously set. The angle θ is an angle which defines a direction in which the additional object will move (with respect to the horizontal rightward direction corresponding to 0 degree as viewed in the figure), and the distance d is a distance the additional object will move in that direction. To select the placement correction process as the overlap-image correction process, the operator selects the radio button R1 in the process selection window W shown in FIG. 5, and enters the value of the angle θ and the value of the movement distance d of the additional object into input boxes B1 and B2, respectively. The angle θ and the movement distance d are described as the process selection information. Thus, the descriptions of the data about the additional object are appended to the layout data about the document under the action of the appending processor 58 to be described later so that the object is placed in the placement position having the central position P3(x3,y3) expressed by Equations (3) and (4) in place of the planned placement position having the initial central position P2(x2,y2) during the actual addition of the object.
x3=x2+d cos θ (3)
y3=y2+d sin θ (4)

The placement correction process has an advantage in facilitating data processing because it merely translates the placement position without changing the descriptions of the data about the additional object.

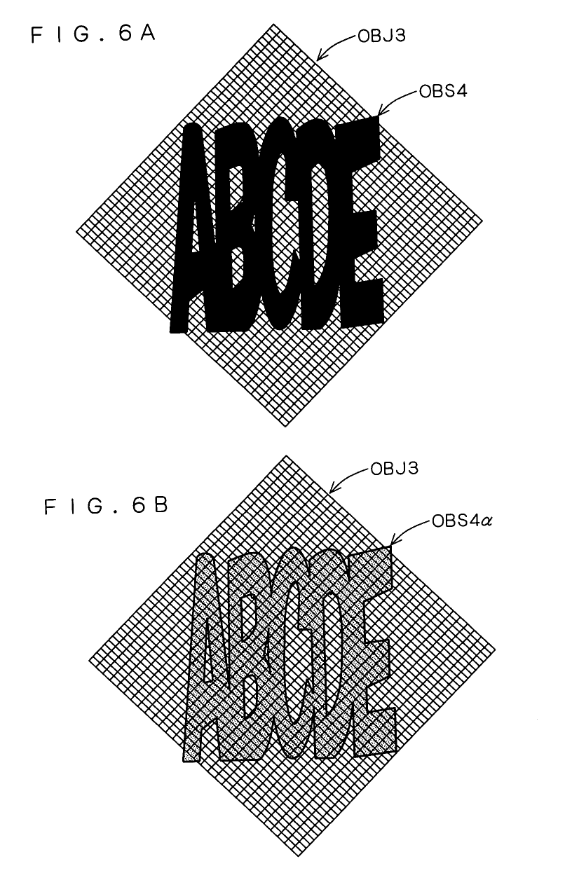

The first transparentizing processor 55 is responsible for the process (additional object transparentizing process) of transparentizing the additional object to make the existing object visible when it is determined that an overlap occurs between the objects. In the additional object transparentizing process, a transparency α (%) is used to define the degree of transparence, that is, the pixel value (or color density) of each pixel in the overlap region. When each object is represented in the CMYK color system, the pixel value Vα of such a pixel obtained by the additional object transparentizing process for each of the colors C, M, Y and K is given by
Vα=(α/100)V1+((100−α)/100)V2 (5)
where α is the transparency, V1 is the pixel value of any pixel of the existing object which overlaps the additional object, and V2 is the pixel value of the pixel of the additional object to be placed in the same position. FIGS. 6A and 6B show an example of the additional object transparentizing process. FIG. 6A shows that an additional object OBJ4 is overlaid on an existing object OBJ3 without any processing. FIG. 6B shows that an additional object OBJ4α obtained as a result of the additional object transparentizing process using a transparency α of 30% is overlaid on the existing object OBJ3. To select the additional object transparentizing process as the overlap-image correction process, the operator selects the radio button R2 in the process selection window W shown in FIG. 5, and enters the value of the transparency α into an input box B3. Thus, during the actual addition of the object, the pixels values in the overlap region are determined from the transparency α described as the process selection information about the corresponding pixel position and the pixel values of the objects in accordance with Equation (5), and this result is described as the layout data about the corresponding region into the layout data about the document under the action of the appending processor 58 to be described later.

The additional object transparentizing process is suitable, for example, when overlaying the additional object on the existing object without any processing impairs the expressiveness of the existing object because the additional object has a color density higher than that of the existing object.

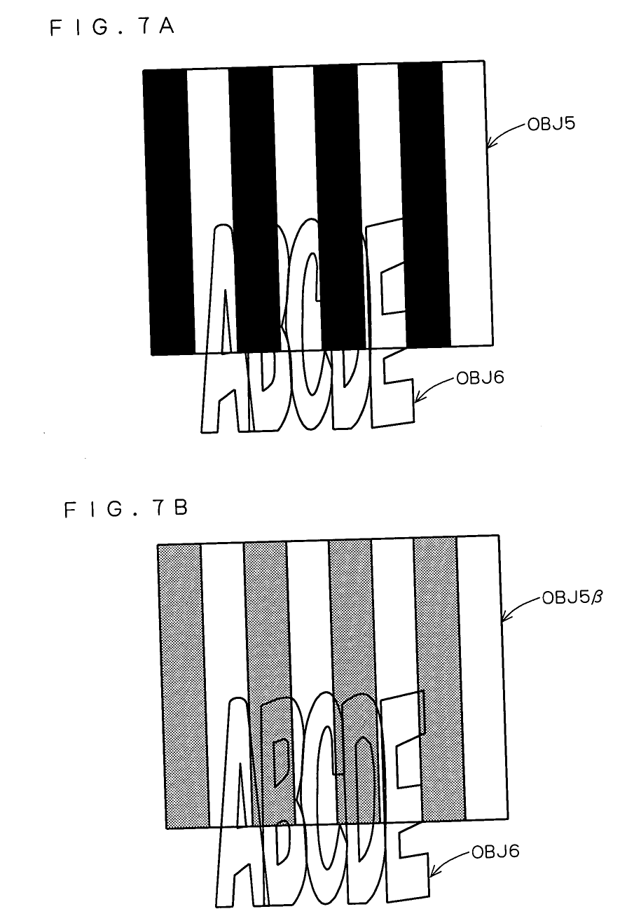

The second transparentizing processor 56 is responsible for the process (existing object transparentizing process) of transparentizing the existing object to make the additional object visible when it is determined that an overlap occurs between the objects. In the existing object transparentizing process, a transparency β (%) is used to define the degree of transparence, that is, the pixel value (or color density) of each pixel in the overlap region. When each object is represented in the CMYK color system, the pixel value Vβ of such a pixel obtained by the existing object transparentizing process for each of the colors C, M, Y and K is given by
Vβ=(100−β)/100)V1+((β/100)V2 (6)
where β is the transparency, V1 is the pixel value of any pixel of the existing object which overlaps the additional object, and V2 is the pixel value of the pixel of the additional object to be placed in the same position. FIGS. 7A and 7B show an example of the existing object transparentizing process. FIG. 7A shows that an additional object OBJ6 is overlaid on an existing object OBJ5 without any processing. FIG. 7B shows that the additional object OBJ6 is overlaid on an existing object OBJ5β obtained as a result of the existing object transparentizing process using a transparency β of 50%. To select the existing object transparentizing process as the overlap-image correction process, the operator selects the radio button R3 in the process selection window W shown in FIG. 5, and enters the value of the transparency β into an input box B4. Thus, during the actual addition of the object, the pixels values in the overlap region are determined from the transparency β described as the process selection information about the corresponding pixel position and the pixel values of the objects in accordance with Equation (6), and this result is described as the layout data about the corresponding region into the layout data about the document under the action of the appending processor 58 to be described later.

The existing object transparentizing process is suitable, for example, when overlaying the additional object on the existing object without any processing impairs the expressiveness of the additional object, e.g. when the additional object contains only an outline and the existing object has a high color density.

The process (overwriting process) of overwriting one of the objects with the other object without any processing may be used when it is determined that an overlap occurs between the objects. The overwriting process is of two types: overwriting the existing object with the additional object; and overwriting the additional object with the existing object. The former corresponds to an instance in which α=0 is substituted into Equation (5) or β=100 is substituted into Equation (6), and the latter corresponds to an instance in which α=100 is substituted into Equation (5) or β=0 is substituted into Equation (6). To select the overwriting process as the overlap-image correction process, the operator selects the radio button R4 in the process selection window W shown in FIG. 5, and places a checkmark in a checkbox B5. Thus, the process of overwriting the existing object with the additional object is selected during the actual addition of the object. Further, the process of overwriting the additional object with the existing object is selected by removing the checkmark from the checkbox B5. During the actual addition of the object, the value of the transparency α or β is determined depending on whether the checkmark is present or absent in the checkbox B5, and the overwriting process is performed.

The deletion processor 57 is responsible for the process (existing object deletion process) of deleting the existing object to place the additional object in the planned placement position when it is determined that an overlap occurs between the objects. This process corresponds to the process of replacing the existing object with the additional object when it is determined that the overlap occurs. To select the existing object deletion process as the overlap-image correction process, the operator selects the radio button R5 in the process selection window W shown in FIG. 5. Thus, the corresponding existing object is deleted, and the appending processor 58 to be described after performs the process of appending the descriptions of data about the additional object to the layout data so as to place the additional object in the planned placement position during the actual addition of the object.

To select the addition of no object to a corresponding page when it is determined that an overlap occurs between the objects, the operator selects the radio button R6 in the process selection window W shown in FIG. 5. In this case, an appending process to be described below is performed only on a page where it is determined that no overlap occurs during the actual addition of the object.

The above-mentioned placement correction processor 54, the first transparentizing processor 55, the second transparentizing processor 56 and the deletion processor 57 correspond to an overlap-image correction processing element according to the present invention.

The appending processor 58 is responsible for the process (appending process) of appending the data about the additional object to the layout data about the document. In this preferred embodiment, the appending process referred to herein shall embrace the process of changing the pixel values in the overlap region from the pixel values in the original layout data in the additional object transparentizing process or the existing object transparentizing process. The appending processor 58 references the placement plan information about the additional object, the process selection information or the pixel value data obtained in the above-mentioned components to perform the process of appending the descriptions of the data about the additional object to the layout data about the document so that the additional object is placed in the document in accordance with the descriptions, that is, the process of combining the data together. In other words, the execution of the appending process provides the document with the additional object placed therein.

The page process determiner 59 determines a process to be performed on each page of the document during the execution of the object addition process. First, the page process determiner 59 references determination result data about the overlap to determine whether or not such a page needs the overlap-image correction process. When no overlap occurs between the objects and there is no need to perform the overlap-image correction process, the page process determiner 59 makes a determination to add the object to the planned placement position without any processing. In response to the determination, the appending processor 58 performs a corresponding appending process. When there is a need for the overlap-image correction process, any one of the above-mentioned components performs a corresponding process based on the descriptions of the process selection information, and thereafter the appending processor 58 performs the appending process based on the corresponding result.

The print job processor 60 is a function principally implemented by the control program 23a, and is responsible for transferring and receiving data to and from the printing machine controller 3, for a rasterizing process and print job entry and execution processes in the printing machine controller 3 by remote-controlling the printing machine controller 3, and for the process of monitoring the operational status of the printing machine 4. The layout data about the document created by the client computer 2 is provided for a printing process based on a predetermined print job under the action of the print job processor 60.

<Overlap Determination and Object Addition>

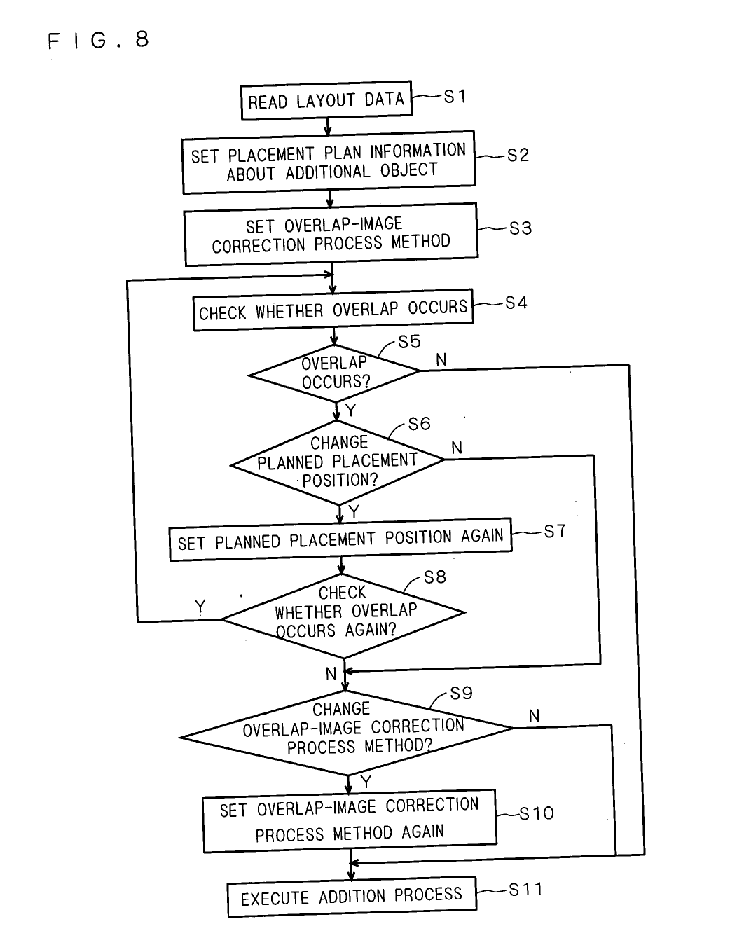

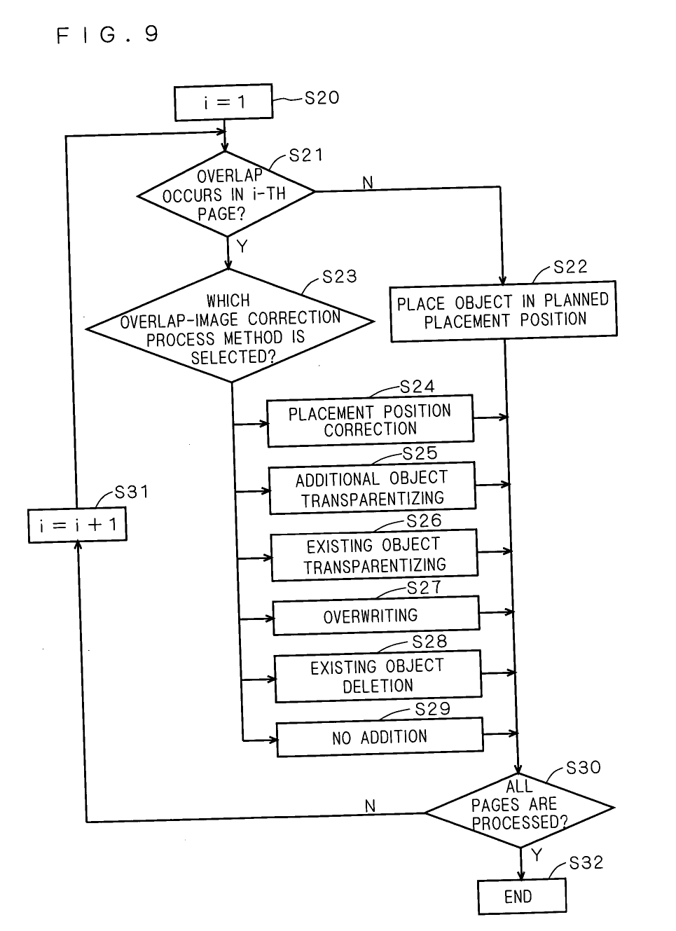

Next, description will be given on a process flow when adding an object to each page of a document. FIG. 8 is a process flow diagram for overlap determination and overlap-image correction process selection. FIG. 9 is a process flow diagram for the object addition process.

First, the layout data about a document to which an object is to be added is read under the action of the data input/output processor 30 (in Step S1). Subsequently, under the action of the placement plan information generator 51, the planned placement position of the additional object is defined, whereby the placement plan information is set (in Step S2). Preferably, the planned placement position can be set while any page suitable for defining the planned placement position which is selected among all pages of the document is displayed.

Next, a method for the overlap-image correction process (or a specific process item) for use when it is determined that the placement of the additional object in the planned placement position causes an overlap between objects is set under the action of the overlap-image correction process selector 53 (in Step S3). An operator presses any one of the radio buttons R1 to R6 to select a corresponding item in the menu indicated in the process selection window W displayed on the display section 22, and enters a predetermined parameter depending on the item. The process selection information is generated from the selection and the entered parameter value. The process selection information is referenced during the object addition process in the later stage.

Next, the overlap determination process for checking whether or not an overlap occurs between the objects in the planned placement position is executed sequentially on all of the pages of the document under the action of the overlap determiner 52 (in Step S4). The processing results are displayed as the determination result data on the display section 22 either one by one each time a page where an overlap occurs is found or in list form after the determination process for all pages is completed. With the results as a reference, the operator contemplates the appropriateness of the planned placement position having been set, to judges whether or not there is a need to change the planned placement position (in Step S6).

When it is determined that an overlap occurs as a result of the overlap determination process (YES in Step S5) and the operator judges that there is a need to change the planned placement position (YES in Step S6), the planned placement position of the additional object is set again under the action of the placement plan information generator 51 (in Step S7). When it is necessary to perform the overlap determination process again for the planned placement position after the setting (YES in Step S8), the processing returns to Step S4 in which the overlap determination process is executed again. When it is not necessary (NO in Step S8), the processing proceeds to the subsequent process.

Next, a judgment is made as to whether or not to change the overlap-image correction process method (in Step S9). There are not only occasions when the change results from the planned placement position which is set again but also occasions when it is judged better to change the initially set overlap-image correction process method than to set the planned placement position again. When there is a need to change the overlap-image correction process method (YES in Step S9), a new process method is selected under the action of the overlap-image correction process selector 53 (in Step S10).

Finally, when it is determined that there is no overlap (NO in Step S5), the processing proceeds to the object addition process for each page (in Step S11). When the planned placement position and the overlap-image correction process method are set again (in Steps S7 and S10), the processing also proceeds to the object addition process for each page (in Step S11).

In the object addition process, the i-th page (where i is a natural number) denotes a page to be processed. First, the initial value (i=1) indicating a starting page is set under the action of the page process determiner 59 (in Step S20). This is not necessarily limited to the first page (page 1) of the document, but the starting page of a predetermined range of pages to be processed may be processed as the first page.

The processing of the i-th page will be considered. First, the page process determiner 59 references the result for the i-th page in the determination result data (in Step S21). When it is determined in the determination result data that no overlap occurs on the i-th page (NO in Step S21), the object is placed in the set planned placement position without any processing (in Step S22). Specifically, the appending processor 58 appends the data indicating the description of the object and the data indicating the placement position (the data indicating that the placement in the planned placement position on the i-th page) to the layout data about the document of interest.

When it is determined in the determination result data that an overlap occurs on the i-th page (YES in Step S21), reference is made to the process selection information indicating the overlap-image correction process method set in Step S3 or Step S10 (in Step S23). When the selected method is the placement position correction process, the placement correction processor 54 corrects the planned placement position in accordance with the values of the angle θ and distance d entered in the input boxes B1 and B2 and described as parameters in the process selection information, and thereafter the appending processor 58 performs the appending process (in Step S24). When the selected method is the additional object transparentizing process, the first transparentizing processor 55 performs the process of calculating the pixel values in the overlap region in accordance with the value of the transparency α entered in the input box B3 and described as a parameter in the process selection information, and thereafter the appending processor 58 performs the appending process (in Step S25). When the selected method is the existing object transparentizing process, the second transparentizing processor 56 performs the process of calculating the pixel values in the overlap region in accordance with the value of the transparency β entered in the input box B4 and described as a parameter in the process selection information, and thereafter the appending processor 58 performs the appending process (in Step S26). When the selected method is the overwriting process, the first transparentizing processor 55 or the second transparentizing processor 56 obtains the pixel values in the overlap region in accordance with the overwriting method depending on the presence or absence of the checkmark in the checkbox B5, and thereafter the appending processor 58 performs the appending process (in Step S27). When the selected method is the existing object deletion process, the deletion processor 57 performs the process of deleting the existing object in the overlap region, and thereafter the appending processor 58 performs the appending process (in Step S28). When the selected method is the process of adding no object, no processes are performed (in Step S29), but the processing proceeds to the next step, with the original state held intact.

After the process for the i-th page is thus completed, the process is subsequently performed if the addition process for the next ((i+1)th) and its subsequent pages remains (YES in Step S30, and in Step S31). Thus, the addition process is automatically performed sequentially on each page. When the process for all of the pages to be processed is completed, the processing is terminated (in Step S32). Thus, new layout data with the additional object combined therewith is completed.

As described hereinabove, when adding the same object to each page in the document with the plurality of pages, the first preferred embodiment previously makes a determination for all pages as to whether or not an overlap occurs between the object originally existing in the document and the additional object, and previously sets a process method in the case of the occurrence of the overlap. Thereafter, the first preferred embodiment automatically performs the object addition process sequentially on each page in accordance with the determination results and the settings of the process method. Because the overlap-image correction process method is selectable, the method suitable for the contents of the print is used for processing even if the overlap occurs. This efficiently accomplishes the addition of the object while impairing the expressiveness of the original document and the expressiveness of the additional object as little as possible. Further, the first preferred embodiment can easily change the planned placement position if the planned placement position is improper. This greatly simplifies operator's operation, and achieves the reduction in total processing time associated with the object addition. The greater the number of pages of the document is, the more pronouncedly these effects are exerted. Furthermore, the use of the same criteria for determination of the presence or absence of the overlap-image correction process, and the same details of processing contributes to an improvement in quality (or workmanship) of the printed matter obtained from new layout data without variations in processing results.

### Second Preferred Embodiment

The above-mentioned first preferred embodiment employs a batch operation in which the object addition process is performed after the determination is made as to whether or not an overlap occurs between the objects, for all pages of the document to which the object is desired to be added. Alternatively, another operation may be performed in which the determination as to whether or not an overlap occurs and the object addition process depending on the result of the determination are performed on individual pages one by one. Such an operation will be described according to a second preferred embodiment of the present invention. Because the second preferred embodiment is implementable by the printing system 1 and the client computer 2 thereof according to the first preferred embodiment, the description about the system construction and the like will be dispensed with.

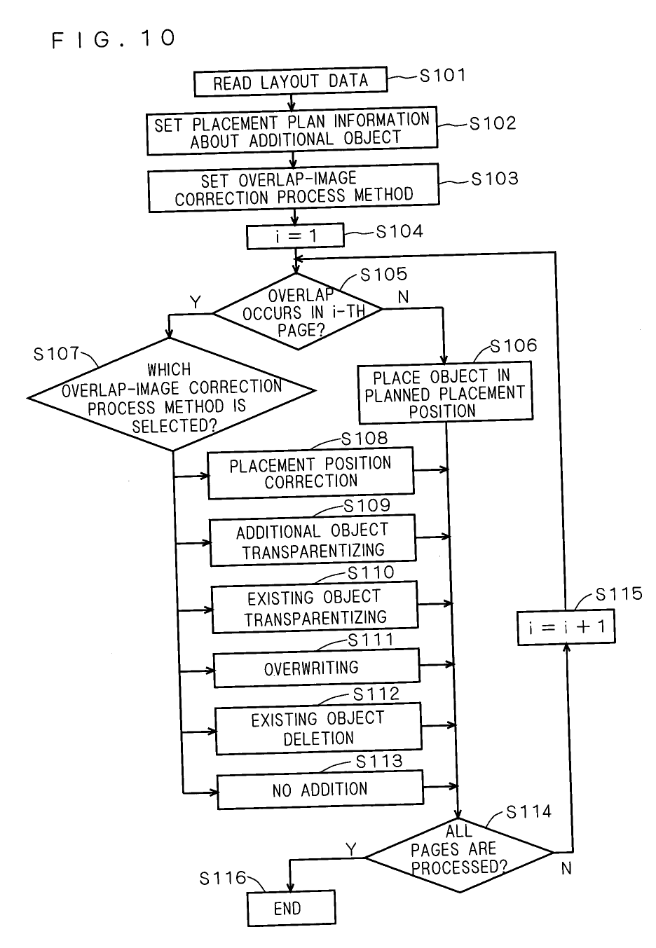

FIG. 10 is a process flow diagram according to the second preferred embodiment of the present invention. First, the layout data about a document to which an object is to be added is read under the action of the data input/output processor 30 (in Step S101). Subsequently, the placement plan information about the additional object is set under the action of the placement plan information generator 51 (in Step S102). Preferably, the planned placement position can be set while any page suitable for defining the planned placement position which is selected among all pages of the document is displayed.

Next, a method for the overlap-image correction process for use when it is determined that the placement of the additional object in the planned placement position causes an overlap between objects is set under the action of the overlap-image correction process selector 53 (in Step S103). An operator presses any one of the radio buttons R1 to R6 to select a corresponding item in the menu indicated in the process selection window W displayed on the display section 22, and enters a predetermined parameter depending on the item. The process selection information is generated from the selection and the entered parameter value. The process selection information is referenced during the object addition process in the later stage.

After the establishment of the overlap-image correction process method, the processing proceeds to the overlap determination process and the object addition process for each page. In these processes, the i-th page (where i is a natural number) denotes a page to be processed, as in the first preferred embodiment. First, the initial value (i=1) indicating a starting page is set under the action of the page process determiner 59 (in Step S104). This is not necessarily limited to the first page (page 1) of the document, but the starting page of a predetermined range of pages to be processed may be processed as the first page.

The processing of the i-th page will be considered. First, the overlap determination process for checking whether or not an overlap occurs between the objects in the planned placement position is executed on the i-th page of the document under the action of the overlap determiner 52 (in Step S105). The page process determiner 59 determines the subsequent process for the i-th page, based on the consequently obtained determination result data for the i-th page (in Step S105).

When the determination result data shows that no overlap occurs on the i-th page (NO in Step S105), the object is placed in the set planned placement position without any processing under the action of the page process determiner 59 (in Step S106). Specifically, the appending processor 58 appends the data indicating the description of the object and the data indicating the placement position (the data indicating that the placement in the planned placement position on the i-th page) to the layout data about the document of interest.

When the determination result data shows that an overlap occurs on the i-th page (YES in Step S105), reference is made to the process selection information indicating the overlap-image correction process method set in Step S103 under the action of the page process determiner 59 (in Step S107). When the selected method is the placement position correction process, the placement correction processor 54 corrects the planned placement position in accordance with the values of the angle θ and distance d entered in the input boxes B1 and B2 and described as parameters in the process selection information, and thereafter the appending processor 58 performs the appending process (in Step S108). When the selected method is the additional object transparentizing process, the first transparentizing processor 55 performs the process of calculating the pixel values in the overlap region in accordance with the value of the transparency α entered in the input box B3 and described as a parameter in the process selection information, and thereafter the appending processor 58 performs the appending process (in Step S109). When the selected method is the existing object transparentizing process, the second transparentizing processor 56 performs the process of calculating the pixel values in the overlap region in accordance with the value of the transparency β entered in the input box B4 and described as a parameter in the process selection information, and thereafter the appending processor 58 performs the appending process (in Step S110). When the selected method is the overwriting process, the first transparentizing processor 55 or the second transparentizing processor 56 obtains the pixel values in the overlap region in accordance with the overwriting method depending on the presence or absence of the checkmark in the checkbox B5, and thereafter the appending processor 58 performs the appending process (in Step S111). When the selected method is the existing object deletion process, the deletion processor 57 performs the process of deleting the existing object in the overlap region, and thereafter the appending processor 58 performs the appending process (in Step S112). When the selected method is the process of adding no object, no processes are performed (in Step S113), but the processing proceeds to the next step, with the original state held intact.

After the process for the i-th page is thus completed, the process is subsequently performed if the process for the next ((i+1)th) and its subsequent pages remains (YES in Step S114, and in Step S115). Thus, the overlap determination process and the addition process are automatically performed sequentially on each page. When the process for all of the pages to be processed is completed, the processing is terminated (in Step S116). Thus, new layout data with the additional object combined therewith is completed.

Although not producing the effect of judging the appropriateness of the planned placement position prior to the addition process, the second preferred embodiment efficiently accomplishes the addition of the object while impairing the expressiveness of the original document and the expressiveness of the additional object as little as possible, in a similar manner to the first preferred embodiment. For instance, if it is previously known that the probability of the need to change the planned placement position is small, e.g. if the original document has already been created as printed matter and the planned placement position can be set based on the original document, the second preferred embodiment requires smaller amounts of data to be handled and shorter processing time than the first preferred embodiment because the need is eliminated for the processes of previously creating the result determination data and referencing the same.

<Modifications>

The above-mentioned preferred embodiments show that the placement correction process adopts only the translation of the additional object, but may allow the rotation of the additional object. Further, the position correction may be set using the amounts of movement in the vertical and horizontal directions, in place of the angle θ and the movement distance d.

In the above-mentioned preferred embodiments, the additional object transparentizing process and the existing object transparentizing process perform the transparentizing process on the entire object if the object overlaps another object even partially. However, the transparentizing process may be performed only on pixels at which an overlap actually occurs.

In the above-mentioned preferred embodiments, only one overlap-image correction process is selected. However, a plurality of overlap-image correction processes may be used in combination, or the process method may be determined depending on the degree of the overlap.

The above-mentioned preferred embodiments are applicable not only to the addition of an object to a region to be printed actually on a print, but also to the addition of information about data management to be referenced in the steps of a printing process flow to a region which is outside a region to be printed and which will not be printed or to a region which will be printed but thereafter be cut off in a later step. An example of such information includes predetermined information given from an operator of the client computer 2 to an operator of the printing machine controller 3, and predetermined marking information to be referenced in a later step after the printing.

Furthermore, it is not always necessary to add an object of the same data descriptions to all pages. For example, objects of different descriptions may be added to the individual pages, in association with page numbers. An example of this modification includes the addition of page numbers and chapter numbers, and the addition of individual objects to respective chapters.

While the invention has been described in detail, the foregoing description is in all aspects illustrative and not restrictive. It is understood that numerous other modifications and variations can be devised without departing from the scope of the invention.

1. A document processor for additionally placing a predetermined object onto at least one page of a document to be printed, comprising:
a) a placement plan information generation element for generating placement plan information, said placement plan information including a layout size of a first object to be additionally placed in said document, and a planned placement position of said first object in said document;
b) an overlap determination element for performing an overlap determination process, said overlap determination process being the process of making a determination for each page as to whether or not an overlap occurs between said first object and a second object when said first object is additionally placed in said planned placement position, said second object being an object already existing in said document;
c) at least one overlap-image correction processing element for performing a predetermined overlap-image correction process, in accordance with process selection information, on a page where it is determined that an overlap occurs by said overlap determination element, said overlap-image correction process being image processing for reducing invisibility resulting from the overlap between said first and second objects, said overlap-image correction process being performed on at least one of said first object and said second object;
d) an overlap-image correction process selection element capable of selection of said overlap-image correction process among a plurality of types of overlap-image correction process candidates to generate said process selection information in the form of information containing a result of said selection;
e) a page process determination element for performing a page determination process, said page determination process being the process of determining a method of addition of said first object for each page by reference to said placement plan information and said process selection information; and
f) an appending processing element for appending data descriptions about said first object to layout data about said document in accordance with the method determined by said page process determination element, to create new layout data about said document.

2. The document processor according to claim 1, wherein
said at least one overlap-image correction processing element is at least one selected from the group consisting of:
c-1) a placement correction processing element for performing a placement correction process, said placement correction process being the process of changing the placement position of said first object to a position different from said planned placement position;
c-2) a first transparentizing processing element for performing a first object transparentizing process, said first object transparentizing process being the process of transparentizing said first object in accordance with a predetermined transparency;
c-3) a second transparentizing processing element for performing a second object transparentizing process, said second object transparentizing process being the process of transparentizing said second object in accordance with a predetermined transparency; and
c-4) a deletion processing element for performing a deletion process on said second object, said deletion process being the process of deleting said second object.

3. The document processor according to claim 2, wherein
said overlap determination process is performed on all pages included in said document and to be subjected to the addition of said first object, and thereafter the addition of said first object is made sequentially to each page in accordance with a result of said page determination process.

4. The document processor according to claim 3, wherein
after said overlap determination process, at least one of said planned placement position and said overlap-image correction process having been selected is allowed to be set again.

5. The document processor according to claim 2, wherein
said overlap determination process and the addition of said first object in accordance with a result of said page determination process are performed on individual pages one by one, said individual pages being included in said document and to be subjected to the addition of said first object.

6. A printing system comprising:
a) a printing machine;
b) a controller for controlling said printing machine; and
c) a document processor for additionally placing a predetermined object onto at least one page of a document to be printed, said document processor including
c-1) a placement plan information generation element for generating placement plan information, said placement plan information including a layout size of a first object to be additionally placed in said document, and a planned placement position of said first object in said document,
c-2) an overlap determination element for performing an overlap determination process, said overlap determination process being the process of making a determination for each page as to whether or not an overlap occurs between said first object and a second object when said first object is additionally placed in said planned placement position, said second object being an object already existing in said document,
c-3) at least one overlap-image correction processing element for performing a predetermined overlap-image correction process, in accordance with process selection information, on a page where it is determined that an overlap occurs by said overlap determination element, said overlap-image correction process being image processing for reducing invisibility resulting from the overlap between said first and second objects, said overlap-image correction process being performed on at least one of said first object and said second object,
c-4) an overlap-image correction process selection element capable of selection of said overlap-image correction process among a plurality of types of overlap-image correction process candidates to generate said process selection information in the form of information containing a result of said selection,
c-5) a page process determination element for performing a page determination process, said page determination process being the process of determining a method of addition of said first object for each page by reference to said placement plan information and said process selection information, and
c-6) an appending processing element for appending data descriptions about said first object to layout data about said document in accordance with the method determined by said page process determination element, to create new layout data about said document.

7. The printing system according to claim 6, wherein
said controller and said document processor constitute a computer network; and
said controller is a computer serving as a server, and said document processor is a client computer of said server.

8. A method of additionally placing a predetermined object onto at least one page of a document to be printed, said method comprising the steps of:
a) generating placement plan information, said placement plan information including a layout size of a first object to be additionally placed in said document, and a planned placement position of said first object in said document;
b) making a determination for each page as to whether or not an overlap occurs between said first object and a second object when said first object is additionally placed in said planned placement position, said second object being an object already existing in said document;
c) selecting an overlap-image correction process to be performed on a page where it is determined that an overlap occurs in said step b) among a plurality of types of overlap-image correction process candidates, said overlap-image correction process being image processing for reducing invisibility resulting from the overlap between said first and second objects, said overlap-image correction process being performed on at least one of said first object and said second object;
d) generating process selection information containing a result of the selection;
e) performing said overlap-image correction process by a predetermined overlap-image correction processing element in accordance with said process selection information;
f) referencing said placement plan information and said process selection information to determine a method of addition of said first object for each page; and
g) appending data descriptions about said first object to layout data about said document in accordance with the method determined in said step f), to create new layout data about said document.

9. The method according to claim 8, wherein
said step e) includes at least one of the steps of:
changing the placement position of said first object to a position different from said planned placement position;
transparentizing said first object in accordance with a predetermined transparency;
transparentizing said second object in accordance with a predetermined transparency;
deleting said second object; and
stopping the addition of said first object.

10. The method according to claim 9, wherein
said step b) is performed on all pages included in said document and to be subjected to the addition of said first object, and thereafter the addition of said first object is made sequentially to each page in accordance with a result of said step f).

11. The method according to claim 10, wherein
after said step b), at least one of said planned placement position and said overlap-image correction process having been selected is set again.

12. The method according to claim 9, wherein
said step b) and the addition of said first object in accordance with a result of said step f) are performed on individual pages one by one, said individual pages being included in said document and to be subjected to the addition of said first object.

13. A program, when executed by a computer, for causing said computer to function as a document processor for additionally placing a predetermined object onto at least one page of a document to be printed, said document processor comprising:
a) a placement plan information generation element for generating placement plan information, said placement plan information including a layout size of a first object to be additionally placed in said document, and a planned placement position of said first object in said document;
b) an overlap determination element for performing an overlap determination process, said overlap determination process being the process of making a determination for each page as to whether or not an overlap occurs between said first object and a second object when said first object is additionally placed in said planned placement position, said second object being an object already existing in said document;
c) at least one overlap-image correction processing element for performing a predetermined overlap-image correction process, in accordance with process selection information, on a page where it is determined that an overlap occurs by said overlap determination element, said overlap-image correction process being image processing for reducing invisibility resulting from the overlap between said first and second objects, said overlap-image correction process being performed on at least one of said first object and said second object;
d) an overlap-image correction process selection element capable of selection of said overlap-image correction process among a plurality of types of overlap-image correction process candidates to generate said process selection information in the form of information containing a result of said selection;
e) a page process determination element for performing a page determination process, said page determination process being the process of determining a method of addition of said first object for each page by reference to said placement plan information and said process selection information; and
f) an appending processing element for appending data descriptions about said first object to layout data about said document in accordance with the method determined by said page process determination element, to create new layout data about said document.
